(19) United States
(12) Patent Application Publication
(10) Pub. No.: US 2011/0108452 A1
(43) Pub. Date: May 12, 2011

(54) PACKAGE FOR SECURING A BLISTER PACK

(75) Inventor: John A. Gelardi, Midlothian, VA (US)

(73) Assignee: MEADWESTVACO CORPORATION, Richmond, VA (US)

(21) Appl. No.: 13/002,557

(22) PCT Filed: Jul. 17, 2009
(86) PCT No.: PCT/US09/50954

§ 371 Date: Jan. 4, 2011

Related U.S. Application Data
(60) Provisional application No. 61/081,921, filed on Jul. 18, 2008.

(51) Int. Cl. A61J 1/03; B65D 75/36; B65D 83/04

(52) U.S. Cl. 206/532; 206/471

(57) ABSTRACT

There is disclosed a sleeve package (10,12) having an interior chamber adapted to receive and securely contain a blister pack (13). The blister pack (13) includes at least one retaining hole (14) and a locking hole (9). The sleeve package (10,12) includes a top (10) and a bottom piece (12) snap fitted to form the sleeve package. The top piece (10) further includes a partially cut out tab portion (11) that can be deflected inward from the surface of the top piece (10), a retaining catch mechanism (17) oriented to engage the at least one retaining hole (14) of the blister pack, and a locking post (19) oriented and adapted to engage the locking hole (9). The bottom piece (12) includes raised ribs (15) such that the blister pack (13) is seated on the raised ribs within the interior chamber. The blister pack (13) is locked within the sleeve package (10,12) when the locking hole (9) engages the locking post (19) and unlocked when the cut out tab portion (11) is depressed.

### BACKGROUND OF THE INVENTION

One form of pharmaceutical packaging is a blister pack. A blister pack is a generally flat substrate on one side and a plurality of bubble like cavities on the other side. Within each cavity is stored a unit dose of a pharmaceutical such as a pill, tablet, or capsule. The contents within the cavity need not be pharmaceutical per se, however. When a consumer wishes to access the contents of a blister, he presses down on the cavity ‘bubble’ causing the contents to pierce the bottom surface (usually foil or the like) of the blister pack.

Blister packs are a convenient primary form of packaging. However, blister packs generally require a secondary form of packaging. The secondary form of packaging serves to protect the blister pack as well as providing a convenient form for labeling. More importantly, however, the secondary packaging can also provide a means for securing the blister pack from children as a safety feature since the contents of the blister packs can often be dangerous.

One of the safety measures associated with the secondary packaging is the ability to ‘lock’ and ‘unlock’ a blister pack within a secondary package. Secondary packages have been comprised of many materials including paperboard packaging solutions and hard plastic shell type solutions. In general, the secondary packages receive a blister pack and can securely seat it within a chamber such that it can not be withdrawn without manipulating a locking mechanism. A typical locking mechanisms include catches that prevent the blister from being withdrawn unless a tab type mechanism can be separated from a tab catch mechanism.

In the hard plastic shell solutions, the locking and release mechanisms have been situated on what would generally be considered the bottom of the secondary package and the blister pack slides out in an upside-down orientation. This means the consumer has to turn the entire packaging solution over when the blister pack is withdrawn in order to access the blister cavity.

What is needed is a hard plastic sleeve packaging solution that places the locking/unlocking mechanism on the top surface of the hard plastic shell and permits withdrawal of a blister pack right side up in which the blister cavities are visible upon withdrawal.

### SUMMARY OF THE INVENTION

In one embodiment there is disclosed a sleeve package having an interior chamber adapted to receive and securely contain a blister pack. The blister pack includes at least one retaining hole and a locking hole. The sleeve package includes a top piece having an inner and outer surface. The top piece further includes a partially cut out tab portion that can be deflected inward from the surface of the top piece, at least one retaining catch mechanism oriented to engage the at least one retaining hole of the blister pack, and a locking post oriented and adapted to engage the locking hole. The locking post slopes generally downward from back to front. The sleeve package further includes a bottom piece having an inner and outer surface that can be coupled with the top piece via a snap fit to form the sleeve package. The bottom piece includes a plurality of raised ribs such that the blister pack is seated on said raised ribs within the interior chamber. The blister pack is locked within the sleeve package interior chamber when the blister pack locking hole engages the locking post. The blister pack is unlocked when the cut out tab portion is depressed disengaging the blister pack locking hole from the locking post. The top piece can further include at least one guide rail adapted to maintain the blister pack in proper orientation within the sleeve package and a thumb/finger indent positioned at the front edge of the top and/or bottom piece to assist a person when grasping a blister pack contained within the sleeve package.

In another embodiment there is disclosed a sleeve package having an interior chamber adapted to receive and securely contain a blister pack. The blister pack includes at least one retaining hole and a locking flap. The sleeve package includes a top piece having an inner and outer surface. The top piece further includes a partially cut out tab portion that can be deflected inward from the surface of the top piece, at least one retaining catch mechanism oriented to engage the at least one retaining hole of the blister pack, and a locking flap retainer oriented and adapted to engage the locking flap. The locking flap retainer slopes generally downward from back to front. The sleeve package further includes a bottom piece having an inner and outer surface that can be coupled with the top piece via a snap fit to form the sleeve package. The bottom piece includes a plurality of raised ribs such that the blister pack is seated on said raised ribs within the interior chamber. The blister pack is locked within the sleeve package interior chamber when the blister pack locking flap engages the locking flap retainer. The blister pack is unlocked when the cut out tab portion is depressed disengaging the blister pack locking flap from the locking flap retainer. The top piece can further include at least one guide rail adapted to maintain the blister pack in proper orientation within the sleeve package and a thumb/finger indent positioned at the front edge of the top and/or bottom piece to assist a person when grasping a blister pack contained within the sleeve package.

### BRIEF DESCRIPTION OF THE DRAWINGS

FIG. 1 is an exploded top view of the top and bottom pieces that comprise a hard plastic sleeve packaging solution and a blister pack adapted to fit within the hard plastic shell according to one embodiment of the invention.

FIG. 2 is an exploded bottom view of the top and bottom pieces that comprise a hard plastic sleeve packaging solution and a blister pack adapted to fit within the hard plastic shell according to one embodiment of the invention.

FIG. 3 is a top view of the hard plastic sleeve packaging solution showing a blister pack being inserted within the hard plastic shell according to one embodiment of the invention.

FIG. 4 is a clear top view of the hard plastic sleeve packaging solution having a blister pack fully inserted within the hard plastic shell according to one embodiment of the invention.

FIG. 5 is an illustration of the underside of the top piece of a hard plastic shell according to another embodiment of the invention.

FIG. 6 is an illustration of the of the bottom piece of a hard plastic shell according to another embodiment of the invention.

FIG. 7 is a clear top view of the hard plastic sleeve packaging solution having a blister pack fully inserted within the hard plastic shell according to another embodiment of the invention.

FIG. 8 is a clear side view of the hard plastic sleeve packaging solution having a blister pack fully inserted within the hard plastic shell according to another embodiment of the invention.

### DETAILED DESCRIPTION OF THE EMBODIMENTS

The present invention describes an improved hard plastic shell secondary package adapted to receive and house a typical blister pack. For ease of description, the hard plastic shell is also referred to as a sleeve package throughout this disclosure. The sleeve package is generally formed from two pieces of plastic (top and bottom) that snap fit to one another. Once fitted together, one end of the sleeve package remains substantially open and an interior chamber is formed that is adapted to receive and house a blister pack. There are one or more locking and unlocking mechanisms on and about the sleeve package and the blister pack that operate to securely retain the blister pack within the sleeve package. To withdraw and expose the blister pack, a consumer must know how to operate the sleeve package to release the locking mechanism(s). These locking mechanisms provide the entire packaging solution with an enhanced degree of child resistant safety features.

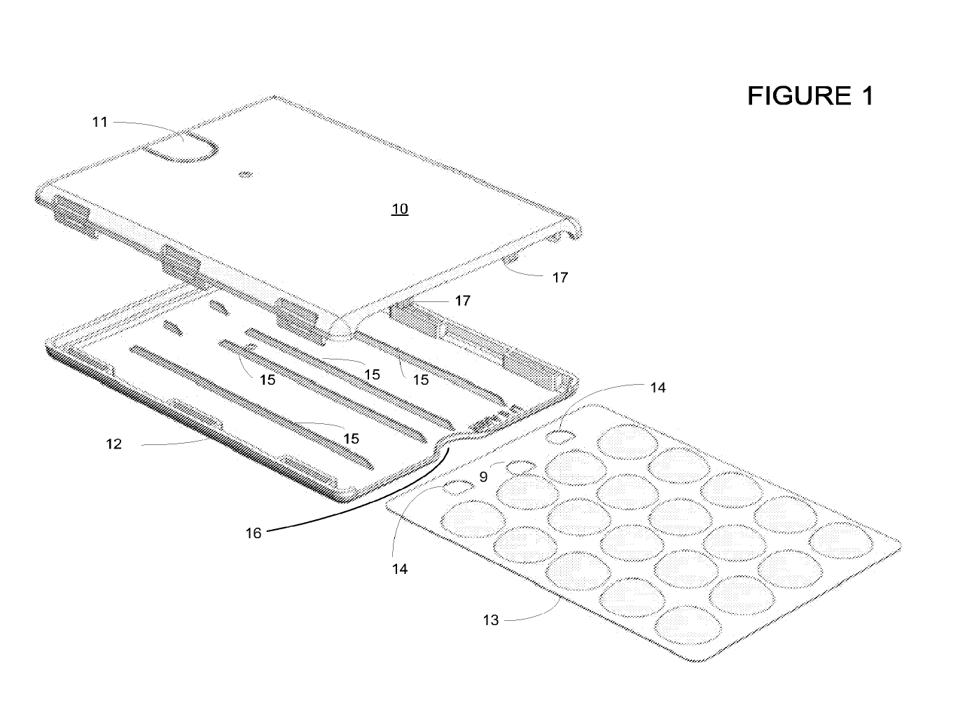

FIG. 1 is an exploded top view of the top 10 and bottom 12 pieces that comprise the sleeve package and a blister pack 13 adapted to fit within the hard plastic shell according to one embodiment of the invention. The top piece 10 includes a cut out tab portion 11 and that will unlock a blister pack 13 that is fully inserted in the sleeve package. A pair of retaining catches 17 are partially shown. These mechanisms and their operation will be more fully described later. The bottom piece 12 includes a plurality of raised ribs 15 that act as the surface on which the flat side of the blister pack 13 will be seated when inserted within the sleeve package. The raised ribs 15 provide a small elevation such that the blister pack does not sit directly on the surface of the bottom piece 12. The space created by the raised ribs 15 is used in the locking and unlocking mechanism that will be described more fully later. The bottom piece 12 also includes a thumb/finger indent 16. The thumb/finger indent 16 is an ergonomic feature that allows a consumer to more easily grasp a blister pack that is fully inserted within a sleeve package.

A blister pack 13 is also shown. The blister pack 13 is shown in the right side up orientation meaning that the cavity side faces up and the flat side faces down. There is at least one retaining hole 14 shown on the leading or front portion of the blister pack 13. These retaining holes 14 are adapted to work in conjunction with reciprocal elements within the sleeve package such as the retaining catches 17 to provide a retaining mechanism. There is also and a locking post (not shown) adapted to work in conjunction with a locking hole 9 on said blister pack. The operation of the locking and retaining mechanisms will be more fully described later.

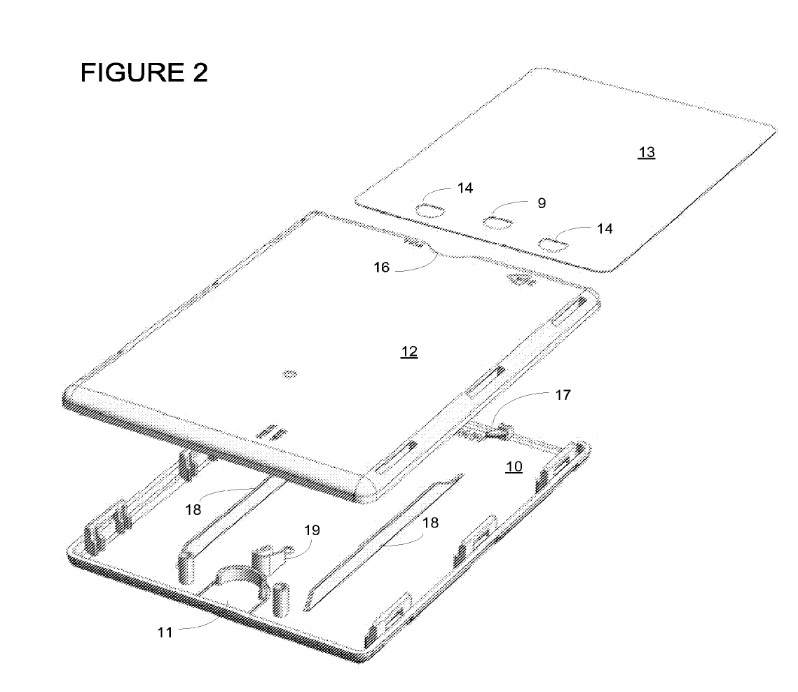

FIG. 2 is an exploded bottom view of the top 10 and bottom 12 pieces that comprise the sleeve package and a blister pack 13 adapted to fit within the hard plastic shell according to one embodiment of the invention. In this illustration, the components have been turned over so that the features not visible in FIG. 1 are more visible. The blister pack 13 is shown with its flat side exposed. The retaining 14 and locking 9 holes are still positioned on the leading or front portion of the blister pack 13. The bottom piece 12 of the sleeve package is shown with thumb/finger indent 16 visible. The top piece 10 of the sleeve package is shown such that its inner surface is exposed. One of the retaining catches 17 can be seen in more detail. A locking post 19 is shown just opposite the cut out tab portion 11. The locking post 19 slopes downward from back to front. Cut out tab portion 11 is shown to have a portion that extends down from the surface of the top piece 10. Also shown are a pair of guide rails 18 that assist in orienting a blister pack 13 that is to be inserted into the sleeve package.

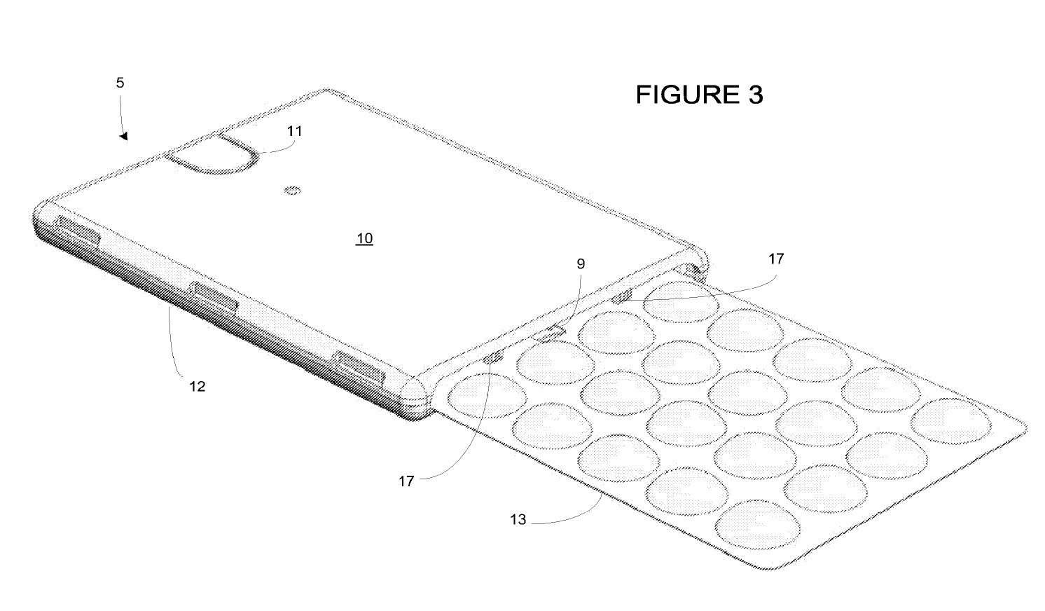

FIG. 3 is a top view of the sleeve package 5 showing a blister pack 13 being inserted within the sleeve package 5 according to one embodiment of the invention. In this illustration the top 10 and bottom 12 pieces of the sleeve package 5 have been snap fitted together using methods and components well known in the art. The top piece 10 includes the cut out tab portion 11 located generally in the rear center portion of the sleeve package 5. The front portion is characterized by an opening capable of receiving the blister pack 13. The blister pack 13 is shown right side up being initially inserted in (or substantially withdrawn from) the sleeve package 5. The locking hole 9 is partially visible on the blister pack 13. The retaining catches 17 affixed to the top piece 10 are also partially visible.

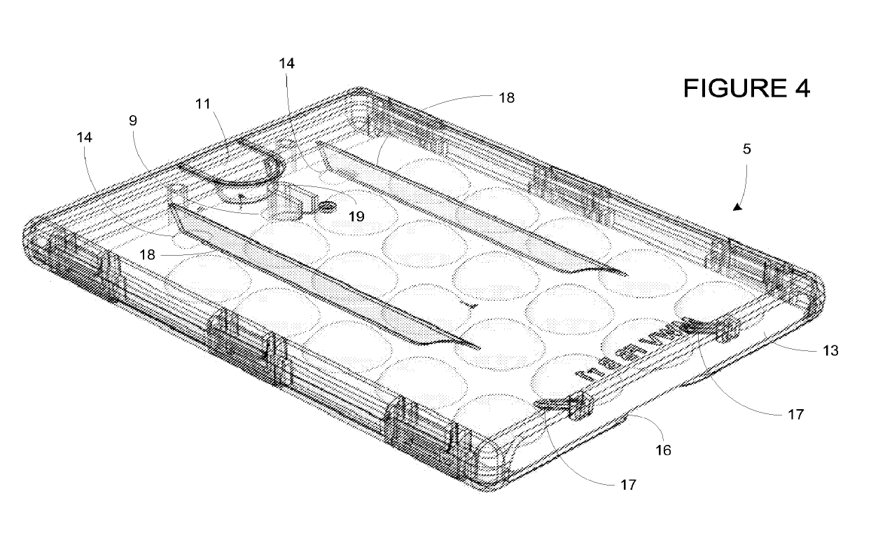

FIG. 4 is a clear top view of the sleeve package 5 having a blister pack 13 fully inserted within the sleeve package 5 according to one embodiment of the invention. This view illustrates how the various locking and retaining mechanisms operate such that the blister pack 13 can be inserted and withdrawn by a consumer right side up. The blister pack 13 is shown fully inserted and locked within the sleeve package 5. If a consumer were to attempt to withdraw the blister pack 13 from the sleeve package 5 without engaging the cut out tab portion 11, the blister pack 13 would remain secured within the sleeve package 5. The blister pack 13 is secured in place by virtue of the orientation between the locking hole 9 of the blister pack 13 and the locking post 19 affixed to the underside of the top piece 10 of the sleeve package 5. The locking post 19 generally protrudes downward from the inner surface of the top piece 10. It also slopes away from front to back somewhat so that the blister pack 13 can relatively easily slide over the locking post 19. Once the blister pack 13 slides over the locking post 19, the locking hole 9, which is aligned with the locking post 19, catches on the locking post 19 thereby preventing withdrawal of the blister pack 13. The guide rails 18 help keep the blister pack 13 aligned and oriented within the sleeve package 5 as they are positioned between rows of cavities of the blister pack 13. While not visible in this illustration, the raised ribs 15 seat the blister pack 13 off the surface of the bottom piece 12. The locking post 19 extends downward beyond the distance that the raised ribs 15 extend upward but not all the way down to the bottom piece 12. Thus, the thin profile of the blister pack 13 can be deflected by the cut out tab portion 11 enough to clear the locking hole 9 from the locking post 19 without pinning the blister pack 13 to the bottom piece 12. The consumer grasps the blister pack 13 with the aid of thumb/finger indent 16 in one hand and holds the rear end of the sleeve package 5 in the other hand such that the thumb can depress the cut out tab portion 11. The cut out tab portion 11 pushes down on the blister pack 13 enough for the locking hole 9 to be cleared of the locking post 19. While holding the sleeve package 5 in this manner the consumer can then begin to withdraw the blister pack 13 since the locking hole 9 has been cleared from the locking post 19. The consumer can continue to with draw the blister pack 13 until almost completely out of the sleeve package 5. The blister pack's locking holes 14 are aligned and oriented to engage the retaining catches 17 to prevent complete removal of the blister pack 13.

In another embodiment of a sleeve package, the locking mechanism is different between the sleeve package and the blister pack. Many of the other elements and components of the sleeve package and blister pack are the same.

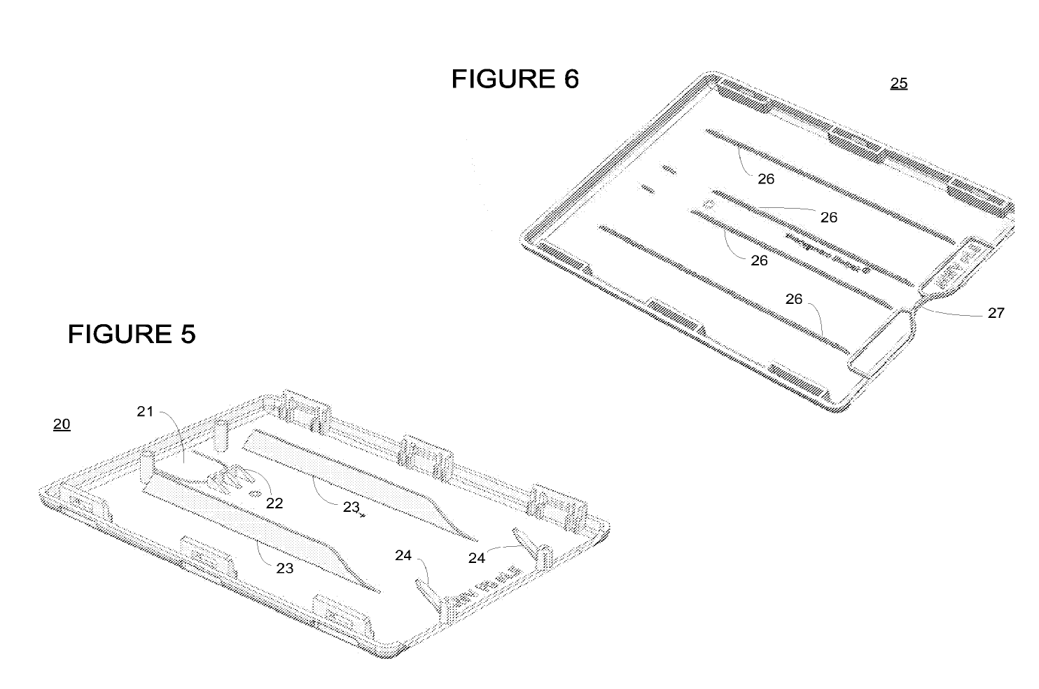

FIG. 5 is an illustration of the underside of the top piece 20 of a sleeve package according to another embodiment of the invention. The top piece 20 includes a cut out tab portion 21, a pair of guide rails 23, and a pair of retaining catches 24. The top piece 20 also includes a locking flap retainer 22 adapted to engage a locking flap on a blister card as will be more fully described later.

FIG. 6 is an illustration of the of the bottom piece 25 of the sleeve package according to another embodiment of the invention. The bottom piece 25 includes a plurality of raised ribs 26 and a thumb/finger indent 27. Just as before, the top 20 and bottom 25 pieces can be snap fitted together to form a sleeve package using elements and techniques well known in the art.

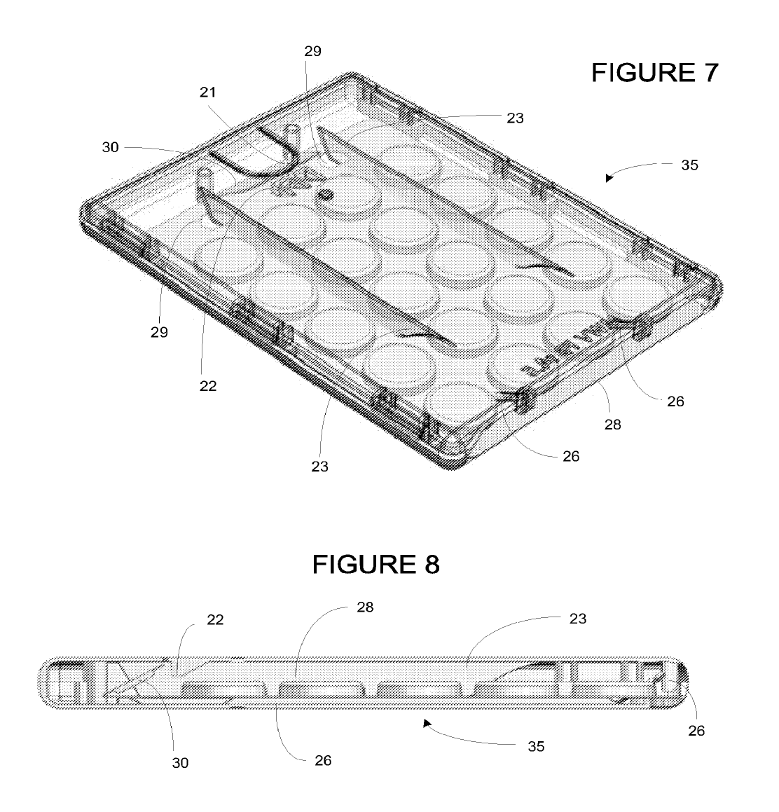

FIG. 7 is a clear top view of the sleeve package 35 packaging solution having a blister pack 28 fully inserted within the sleeve package 35 according to another embodiment of the invention. In this illustration, the blister pack 28 is different from the blister pack 13 used in the previous embodiment. The current blister pack 28 includes a pair of retaining holes 29 that are positioned and oriented to engage a corresponding pair of retaining catches 26 when the blister pack 28 is almost completely withdrawn. However, this embodiment does not utilize an additional locking hole to secure the blister pack 28 in place within the sleeve package 35. Instead, the blister pack 28 includes a locking flap 30 that engages a locking flap retainer 22 when fully inserted within the sleeve package 35 that prevents the blister pack 28 from being withdrawn. The guide rails 23 serve the same purpose as in the previous embodiment, namely, to keep the blister pack 28 oriented and positioned within the sleeve package 35. As the blister pack 28 is inserted into the open end of the sleeve package 35 the locking flap 30 moves along freely since it is fold back over the blister pack 28 somewhat. The leading edge of the locking flap 30 eventually encounters the sloped locking flap retainer 22 and rides along the slope until it clears the locking flap retainer 22.

At this point any effort to withdraw the blister pack 28 will be met with resistance since the locking flap 30 has deployed itself such that it will catch on the locking flap retainer 22 when the blister pack 28 is withdrawn. To remove the blister pack 28, it is necessary to disengage the locking flap 30 from the locking flap retainer 22. This is done with the aid of the cut out tab portion 21. This is achieved when the consumer grasps the blister pack 28 with the aid of thumb/finger indent 27 in one hand and holds the rear end of the sleeve package 35 in the other hand such that the thumb can depress the cut out tab portion 21. The cut out tab portion 21 pushes down on the locking flap 30 enough to clear the locking flap 30 of the locking flap retainer 22. While holding the sleeve package 35 in this manner the consumer can then begin to withdraw the blister pack 28 since the locking flap 30 has been cleared from the locking flap retainer 22 and will not catch on any other impediments. The consumer can continue to with draw the blister pack 28 until almost completely out of the sleeve package 35. The blister pack's retaining holes 29 are aligned and oriented to engage the retaining catches 26 to prevent complete removal of the blister pack 28.

FIG. 8 is a clear side view of the sleeve package 35 packaging solution having a blister pack 28 fully inserted within the sleeve package 35 according to another embodiment of the invention. This view provides a better look at how the locking flap 30 of the blister pack 28 engages the locking flap retainer 22 when the blister pack is fully inserted in the sleeve package 35. Any attempt to withdraw the blister pack 28 without first depressing the cut out tab portion 21 will result in the locking flap 30 resistively engaging the locking flap retainer 22. Only when the cut out tab portion 21 is depressed causing the locking flap 30 to be pushed downward enough to clear the locking flap retainer 22 will the blister pack 28 be able to be withdrawn.

The thumb/finger indents 16, 27 of the embodiments have been illustrated as being part of the bottom pieces 12, 25 of the sleeve package. The thumb/finger indents 16, 27 could just as easily been incorporated into the top pieces 10, 20 or both the top 10, 20 and bottom 12, 25 pieces of the sleeve package 5, 35.

It is believed that the present invention includes many other embodiments that may not be herein described in detail, but would nonetheless be appreciated by those skilled in the art from the disclosures made. Accordingly, this disclosure should not be read as being limited only to the foregoing examples or only to the designated preferred embodiments.

1. A sleeve package having an interior chamber adapted to receive and securely contain a blister pack within the interior chamber wherein the blister pack has a flat side and a cavity side and includes at least one retaining hole and a locking hole, the sleeve package comprising:
a top piece having an inner and outer surface, the top piece including:
a partially cut out tab portion that can be deflected inward from the surface of the top piece;
at least one retaining catch mechanism oriented to engage the at least one retaining hole of the blister pack; and
a locking post oriented and adapted to engage the locking hole, and
a bottom piece having an inner and outer surface wherein the bottom piece can be coupled with the top piece via a snap fit to form the sleeve package, the bottom piece including:
a plurality of raised ribs such that the flat side of the blister pack is seated on said raised ribs within the interior chamber,
wherein the blister pack is locked within the sleeve package interior chamber when the blister pack locking hole engages the locking post and further wherein the cut out tab portion disengages the blister pack locking hole from the locking post when depressed.

2. The sleeve package of claim 1 wherein the top piece further comprises at least one guide rail adapted to maintain the blister pack in proper orientation within the sleeve package.

3. The sleeve package of claim 1 wherein the top piece further comprises a thumb/finger indent at the front edge of the top piece to assist a person when grasping a blister pack contained within the sleeve package.

4. The sleeve package of claim 1 wherein the bottom piece further comprises a thumb/finger indent at the front edge of the bottom piece to assist a person when grasping a blister pack contained within the sleeve package.

5. The sleeve package of claim 1 wherein the locking post slopes downward from back to front.

6. A sleeve package adapted to receive and securely contain a blister pack wherein the blister pack has a flat side and a cavity side and includes a locking flap and at least one locking hole, the sleeve package comprising:
a top piece having an inner and outer surface, the top piece including:
a partially cut out tab portion that can be deflected inward from the surface of the top piece;
at least one retaining catch mechanism oriented to engage the at least one retaining hole of the blister pack; and
a locking flap retainer oriented and adapted to engage the locking flap, and
a bottom piece having an inner and outer surface wherein the bottom piece can be coupled with the top piece via a snap fit to form the sleeve package, the bottom piece including:
a plurality of raised ribs such that the flat side of the blister pack is seated on said raised ribs within the interior chamber,
wherein the blister pack is locked within the sleeve package interior chamber when the blister pack locking flap engages the locking flap retainer and further wherein the cut out tab portion disengages the blister pack locking flap from the locking flap retainer when depressed.

7. The sleeve package of claim 6 wherein the top piece further comprises at least one guide rail adapted to maintain the blister pack in proper orientation within the sleeve package.

8. The sleeve package of claim 6 wherein the top piece further comprises a thumb/finger indent at the front edge of the top piece to assist a person when grasping a blister pack contained within the sleeve package.

9. The sleeve package of claim 6 wherein the bottom piece further comprises a thumb/finger indent at the front edge of the bottom piece to assist a person when grasping a blister pack contained within the sleeve package.

10. The sleeve package of claim 6 wherein the locking flap retainer slopes downward from back to front.
